(19) United States
(12) Patent Application Publication
(10) Pub. No.: US 2023/0248607 A1
(43) Pub. Date: Aug. 10, 2023

(54) Massage Device

(71) Applicant: Eduard Chen, Kronberg (DE)

(72) Inventor: Eduard Chen, Kronberg (DE)

(21) Appl. No.: 18/105,991

(22) Filed: Feb. 6, 2023

(30) Foreign Application Priority Data
Feb. 8, 2022 (DE) 102022000486.0

(51) Int. Cl. A61H 15/00

(52) U.S. Cl. CPC A61H 15/00; A61H 2015/005; A61H 2015/0064; A61H 2205/12

(57) ABSTRACT

A massage device includes spiked massage balls that rotate independently of each other around a shaft that is supported by a mount. The balls rotate on either side of a central bracket. A longitudinally extending body part is massaged by movement thereof through a valley between the massage balls. This valley is accessible by the longitudinally extending body part over an angle that exceeds 180°.

### RELATED APPLICATIONS

Under 35 USC 119, this application claims the benefit of the Feb. 8, 2022 priority date of German application 102022000486.0, the contents of which are incorporated herein by reference.

### BACKGROUND

Massage promotes physical well-being. It also yields demonstrable effects on health that go beyond well-being. Particularly noteworthy in this context is the preventative effect of a massage, for example for mobilizing the cervical and thoracic spine.

### SUMMARY

The present invention provides a simple-to-produce, universally applicable massage device. Despite its simplicity, the massage device provides not only a pleasurable sensation but also medically effective massages. It does so by using the human body's own weight as a source for the force that promotes a therapeutically valuable massage,

As a result of its universal configuration, the massage device is easily adaptable to massage diverse portions of the human anatomy, even though those portions often require fundamentally different massage techniques. The inventive massage device is usable on the upper back, where it effectively mobilizes the cervical and thoracic spine. It is also useful at the opposite end of the body, where it performs foot massages. Use of the massage device on the legs discourages hemostasis and lymph stasis, thereby reducing the risk of deep vein thromboses.

The massage device includes at least one movable massage body. Massage bodies having an uneven surface, for example a surface having grooves or spikes, are particularly suitable. A cylinder or ball is highly suitable as a massage body.

The massage device features a mount that supports a rotational shaft on which the massage body is rotatably mounted. In general, the rotational shaft is guided through the massage body along a rotationally symmetrical axis.

The massage body comprises corresponding openings or through-holes to permit rotation thereof. Some embodiments also include a bearing, such as a ball bearing to promote rotatability. The massage body can thus rotate about the rotational shaft through an angle of rotation.

In some embodiments, the massage body rotates completely around the shaft, i.e., through 360 degrees, with minimal resistance to rotation in both directions of rotation.

When viewed from the rotational shaft, the massage body is freely accessible over an angular range greater than 180 degrees. Geometrically, one can visualize two rays that emerge from a rotating shaft. As is the case for any two rays emerging from a common point, these rays define two angular ranges that, when added together, add up to 360°. The two angular ranges are thus explementary angles, with one being greater than the other. The larger of the two, which is necessarily in excess of 180°, defines an angular range through which that portion of the body to be massaged passes through.

As a result of its extended free angular range, it is therefore possible to move a foot or another body part, for example, toward the massage body without a component being in the way.

Embodiments include those in which the massage body is freely accessible over an angular range of greater than 180 degrees. Among these are embodiments in which the massage body is freely accessible over an angular range of 210 degrees or greater or 270 degrees or greater. In a viewing direction perpendicular to the rotational shaft, no component which could limit the massage body from being freely accessible is provided along a circular arc that extends at least 180 degrees around the rotational shaft.

In some embodiments, the massage device features a mount of the massage device to securely position the rotational shaft on a surface. As used herein, a “mount” is a component that makes it possible to position and use the massage device without the device needing any other manual support. As a result, the mount omits the need to apply pressure to the device or to hold the device still.

Examples of an appropriate surface include a table's surface or a floor or other surface upon which the person being massaged lies.

In some embodiments, a mechanical connection achieves secure positioning of the massage device. In other embodiments, it is sufficient to rely on friction to securely hold the massage device. Among such embodiments are those having feet disposed on an underside thereof. Such feet include resilient feet, feet comprising a material having a high coefficient of friction, such as a high static coefficient of friction. Particularly appropriate materials include a resilient plastic or silicone.

The ability to securely position the massage device on the floor or other surface upon which the person to be massaged lies makes it possible to give a back massage or foot massage in an uncomplicated manner.

Some embodiments comprise two massage bodies that are independently rotatable. As a result, it is possible to rotate them in the same direction or in opposite directions. Rotation in the same direction is useful, for example during a back massage, in which relative motion between the back and both massage bodies rotate them in the same direction. Rotation in opposite directions is useful during, for example, a foot massage, in which one typically moves one's feet in opposite directions.

In some embodiments, the massage body's surface has outwardly protruding spikes, which are preferably resilient and thus adapt to the shape of that portion of the human anatomy upon which they are being rolled. In others, the massage body is hollow.

Embodiments include those in which the massage body is ball shaped. Among these are embodiments in which the massage body is spherical. In other embodiments, the massage body is cylindrical or mostly cylindrical but with tapered ends.

Also among the embodiments are massage bodies that are smooth, i.e., with no spikes. Still other embodiments include those in which the massage bodies have a textured surface, such as those with grooves.

In some embodiments, the massage bodies are capable of being swapped out. This is useful since a massage body can experience wear and many need replacement. It is also possible to swap out massage bodies for different kinds of massage bodies that are perhaps more attuned to a particular body part to be massaged. As a result, it is possible to use massage bodies of different shapes or sizes, having different surfaces, or different strengths.

Embodiments also include those having a centrally supported rotational shaft. Such a support increases the shaft's stability. This is particular important when a large amount of pressure is exerted, such as during a foot massage. A used herein, “centrally” refers to the exact center of the rotational shaft or a central region of no more than 20% of the shaft's length that spans the center.

In some embodiments, the rotational shaft is above a peripheral frame. A “peripheral frame” is one in that extends around the periphery by 360 degrees perpendicularly to the rotational shaft, i.e., for example, when viewed in a plane parallel to the floor. In the height of the rotational shaft, the frame does not have to be peripheral, and preferably is not.

Among those embodiments that have a frame are those in which the frame, or a component thereof, supports the rotational shaft only at two points, for example only at the ends of the shaft. Also among these embodiments are those in which the frame, or a component thereof, supports the shaft at three points, for example, at the two ends and additionally in the center. For this purpose, the frame can comprise projecting support elements. These can be connected to the frame as separate components, but they can also be provided integrally in the frame.

Some embodiments include at most one rotational shaft. In such embodiments, the shaft is centrally arranged or in a mirror plane of the frame.

It is particularly useful for the mount to avoid projecting upward too far. This promotes access to the massage bodies over a larger angular range. The height of the rotational shaft above a supporting surface depends on the massage body's radius. In some embodiments, the ratio of the rotational shaft's height above the supporting surface to that of the massage body's radius is 1.1:2.0. In other embodiments, it is 1.3:1.7.

It is also useful for the mount to project beyond the rotational shaft slightly, but not too far. A useful projection is one in which the mount's upper edge and the rotational shaft's midpoint are separated by a distance that is no greater than a distance that is 10% and 20% of the massage body's radius.

Embodiments include those in which the massage device is manufactured from connected boards. Such construction allows many materials to be used. Examples of such materials include plastic boards, wooden boards, and multiplex boards, such as coated multiplex boards. Moreover, such construction permits the massage device to be easily manufactured in a workshop, such as a carpentry workshop comprising standard equipment.

The rotational shaft can likewise be made of wood. However, some embodiments feature a metal shaft, such as one made of stainless steel.

Some embodiments feature a holder that holds the mount is held above the floor. Such embodiments are particularly suitable for use in a foot massage. In some embodiments, the holder is a freestanding separate component. In others, the holder is an add-on to a piece of furniture, such as a chair or a seat.

In some embodiments, the massage device is mounted to the back of a seat in a manner similar to how one might mount a footrest, such as those that are common in aircraft or train passenger seats. When traveling, for example on an aircraft in which many rows of seats are provided one behind the other, it is thus possible to provide beneficial foot-massage equipment. On long flights, this not only promotes passenger relaxation but also reduces the risk of thromboses. A similar configuration is applicable to automobiles and trains. For example, in some practices, the massage device is attached to one of the front seats in a car, in order to allow the passengers in the back seats to massage their feet.

Embodiments also include those in which the massage device is mounted on a wall, either with or without a holder. A massage device mounted on a vertical plane with the massage bodies exposed to the room's interior enables a person to carry out a brief but relaxing back massage by sidling up against the wall.

In another aspect, the invention features a method for massaging using a massage device comprising two massage bodies. Such a method includes positioning the person who is to be massaged on a seat, positioning the massage device in front of that seat, massaging the person's feet by moving them on the massage device, positioning the person so that the person lies on a surface, positioning the massage device on that surface, and massaging the person's back by causing relative motion between the person's back surface and the massage device.

The steps are preferably performed in the order in which they are listed. However, the orders of the first and second steps and the order of fourth and fifth steps are not significant. It may make sense to arrange the massage device in front of a seat first and to then sit down on the seat. It may also make sense for a person who is to be massaged to sit down on the seat first and for the massage device to then be arranged in front of the seat either by that person or by another person. The same applies to the use of the massage device on a surface upon which a person lies.

As used herein, a “seat” is something that would normally be regarded as being used to sit on, i.e. a stool or chair. The use of the massage device in front of a television chair is often desirable. Examples of a surface upon which a person to be massaged lies include the ground, the floor, a mat, such as a yoga mat, a mattress, and a bed.

A massage method of this kind is possible with few massage aids since these are usually optimized for an area of the body and an application. The present device allows for both types of massage, and both achieve specific added medical value, namely mobilizing the cervical and thoracic spine and preventing hemostasis and lymph stasis.

The method is understood to relate to the massage device according to the invention. This means that features of the design of the product are analogously transferable to the method, and features of the method are analogously transferable to features of the product.

Further features, but also advantages, of the invention will become clear from the drawings explained below and the associated description. Features of the invention are described in combination in the drawings and the associated descriptions. These features may, however, also be found in the subject matter according to the invention in other combinations. Each disclosed feature is therefore also considered to be disclosed in technically meaningful combinations with other features. The drawings have sometimes been slightly simplified and are schematic.

### BRIEF DESCRIPTION OF THE DRAWINGS

FIG. 1 is a perspective overall view of a massage device according to the invention,

FIG. 2 is a plan view of the same massage device,

FIG. 3 is a side view of the massage device, and

FIG. 4 is a sectional view showing a side view of the central support.

### DETAILED DESCRIPTION

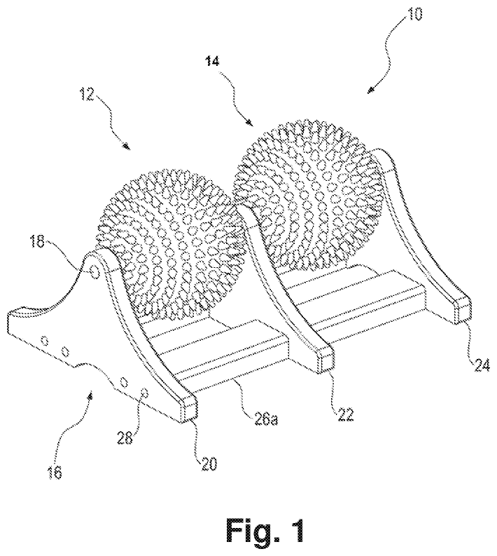

FIG. 1 is a perspective view of a massage device 10 that comprises two massage bodies, namely a first massage ball 12 and a second massage ball 14. The massage balls 12 and 14 are arranged on a mount 16. This mount 16 supports a rotational shaft 18.

The mount 16 comprises a left-hand outer bracket 20, a central bracket 22, and a right-hand outer bracket 24. These three brackets each comprise through-holes for the rotational shaft 18.

The brackets are connected by the rotational shaft. In addition, the brackets are connected by two cross members 26a, 26b, of which the front cross member is visible in FIG. 1. The cross members 26a, 26b can expediently be connected to the outer brackets by threaded joints 28. Like the brackets, the cross members 26a, 26b can be cut out of a board material. This allows for a construction that is particularly simple but still very stable.

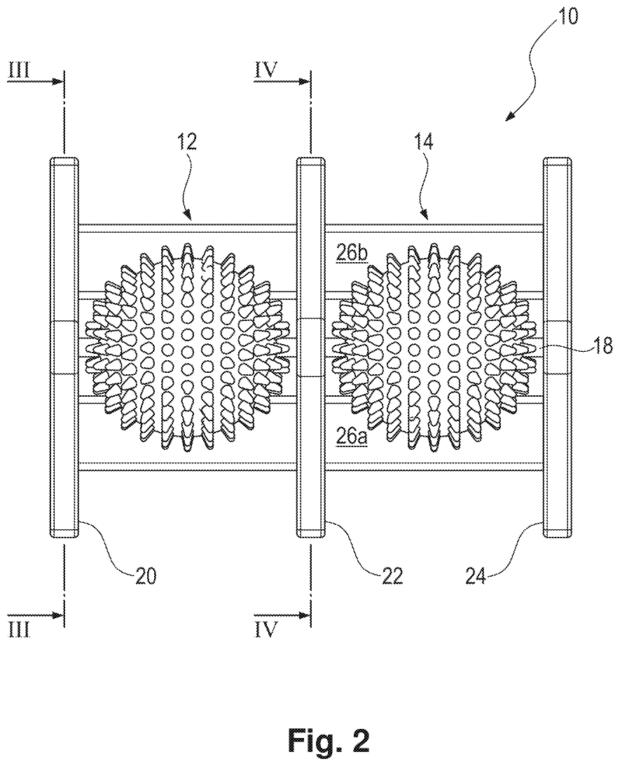

FIG. 2 is a plan view of the massage device 10 shown in FIG. 1. The first massage body 12 is arranged on the left, and the second massage body 14 is arranged on the right. This view clearly shows the cross members 26a, 26b guided in parallel. As a result of having been guided through the central bracket 22, the rotational shaft 18 is supported centrally. This view also clearly shows that the mount 16 extends around the periphery by 360 degrees. The lateral portions are formed by the outer brackets 20, 24. The cross members 26 are arranged therebetween.

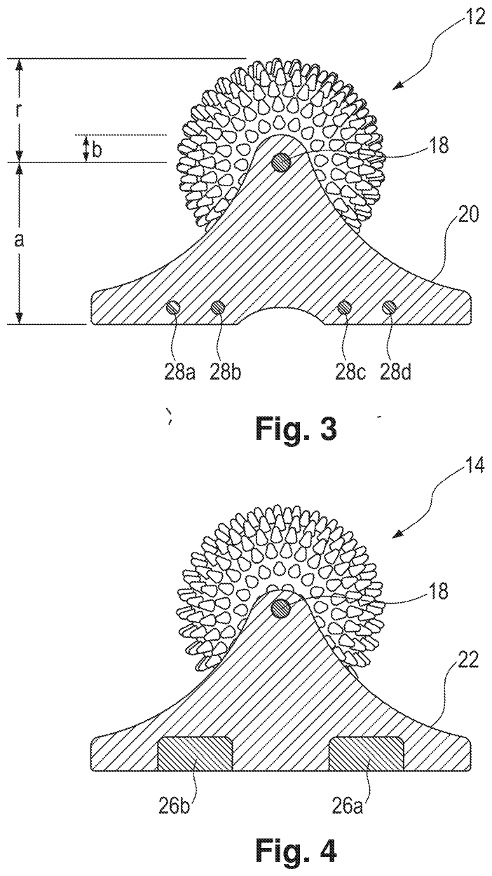

FIG. 3 is a side view along the plane III-III. It is therefore a plan view of the left-hand outer bracket 20. It shows how the outer bracket 20 receives the rotational shaft 18. A bore is provided for this purpose. Alternatively, a blind hole or similar recess would also be suitable. The outer bracket 20 also limits the lateral play that the first massage body 12 has on the rotational shaft 18. In order to limit this play, additional apparatuses can be provided (rings, ball bearings, or the like), but this is not required. In this respect, too, the mount 16 makes it possible to support the massage bodies in both a simple and expedient manner.

The cross members can be rigidly connected to the outer bracket 20 by four bores and fitting threaded joints 28a, 28b, 28c, 28d.

In this case, the outer brackets 20, 24 also assume the function of projecting support elements, and therefore these are not provided as separate components. The lower part of the outer brackets 20, 24 comprises vertical edges and is part of the peripheral mount, and the adjoining upper part is substantially triangular and acts as a support element for the rotational shaft 18.

This side view also shows how the mount 16 can be dimensioned in an expedient manner. The rotational shaft 18 is attached above a supporting surface at a height “a.” This height is somewhat greater than the radius “r” of the massage balls. The mount 16 overall extends beyond the height of the rotational shaft, and namely projects beyond the rotational shaft 18 by the height “b.” This height “b” is, however, intended to be small compared with the radius “r.”

FIG. 4 is a sectional view along the axis IV-IV from FIG. 2. The central bracket 22 comprises a bore for the rotational shaft 18, such that said shaft can be supported centrally without a complex construction. Two cut-outs, through which the cross members 26a and 26b are guided, are provided in the bottom of the central bracket 22. It would also be possible to make the cross members shorter, such that, in each case, one or two cross members connect the left-hand outer bracket to the central bracket and further cross members connect the right-hand outer bracket to the central bracket. It has, however, proven successful to guide the cross members through the central bracket, because this means that a lower number of cross members is required and the left-hand outer bracket 20 can be connected directly to the right-hand outer bracket 24.

Overall, it can be seen how a stable and universally applicable massage device can be manufactured in a simple and expedient manner.

Having described the invention and a preferred embodiment thereof, what is claimed as new and secured by Letters Patent is:

1. An apparatus comprising a massage device, said massage device comprising first and second massage balls, each of which comprises spikes that protrude from a surface thereof, a mount that comprises a left-hand outer bracket, a right-hand outer bracket, and a central bracket that is disposed between said left-hand outer bracket and said right-hand outer bracket, each of said brackets having a base, a first concave section, a second concave section, and a convex section, wherein said base comprises first and second base-ends and a base axis that extends therebetween, and a rotational shaft that extends through said convex sections of said brackets and through through-holes of said first and second massage balls, said rotational shaft being supported by said mount, wherein said first massage ball is disposed to rotate around said rotational shaft between said left-hand outer bracket and said central bracket, wherein said second massage ball is disposed to rotate around said rotational shaft between said right-hand outer bracket and said central bracket, wherein said massage balls rotate independently of each other around said rotational shaft, wherein first and second rays that extend from said rotational shaft to said first and second base ends of said central bracket, respectively define first and second angular ranges that are explementary to each other, said first angular range being greater than said second angular range, and wherein said first and second massage balls define a valley at said central bracket for accommodating a longitudinally extending body part that is to be massaged by movement thereof through said valley between said massage balls while said body part is within said first angular range, whereby said valley that is between said first and second massage balls is accessible by said longitudinally extending body part over an angle that exceeds 180°.

2. The apparatus of claim 1, wherein said first angular range is 270° and said second angular range is 90°.

3. The apparatus of claim 1, wherein said first angular range is between 210° and 270° and said second angular range is between 150° and 90°.

4. The apparatus of claim 1, wherein said first and second massage balls are hollow.

5. The apparatus of claim 1, further comprising a peripheral frame, wherein said rotational shaft is disposed above said frame.

6. The apparatus of claim 1, wherein said rotational shaft is supported centrally.

7. The apparatus of claim 1, wherein said mount is manufactured from connected boards.

8. The apparatus of claim 1, wherein said mount securely positions said rotational shaft on a surface.

9. The apparatus of claim 1, further comprising a holder that holds said mount above a floor.

10. The apparatus of claim 1, further comprising two pairs of feet that support said massage device on a surface.

11. The apparatus of claim 1, further comprising cross members that are connected to said outer brackets by threaded joints.

12. The apparatus of claim 1, wherein each of said massage balls is freely accessible over an angular range of greater than 180°.

13. The apparatus of claim 1, wherein said first and second massage balls are resilient.

14. The apparatus of claim 1, further comprising third and fourth massage balls of a size that differs from that of said first and second massage balls, wherein said first and second massage balls are removable and replaceable by said third and fourth massage balls.

15. The apparatus of claim 1, further comprising first and second massage bodies of a shape that differs from that of said first and second massage balls, wherein said first and second massage balls are removable and replaceable by said first and second massage bodies.

16. The apparatus of claim 1, further comprising first and second massage bodies having a grooved surface, wherein said first and second massage balls are removable and replaceable by said first and second massage bodies.

17. A method comprising massaging a longitudinally extending body part, said method comprising causing said body part to move through an angular range into a valley that is formed between first and second massage balls that rotate independently of each other around a rotational shaft that is supported by a mount having a bracket that has first and second base ends, wherein each of said massage balls comprises spikes protruding from a surface thereof, said angular range being defined by first and second rays that extend from said shaft to each of said first and second base ends, said angular range being greater than 180°.
